(19) United States
(12) Patent Application Publication
(10) Pub. No.: US 2002/0069479 A1
(43) Pub. Date: Jun. 13, 2002

(54) Shock absorbing caster of traveling suitcase

(76) Inventor: Chung-Hsien Kuo, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/766,627

(22) Filed: Jan. 23, 2001

(30) Foreign Application Priority Data
Dec. 13, 2000 (TW) 89221642

(51) Int. Cl. B60B 33/00; A47B 91/00

(52) U.S. Cl. 16/45

(57) ABSTRACT

The present invention proposes a shock absorbing caster of a traveling suitcase, which comprises a caster shell seat, a roller pivotal seat, a roller, a soft component, and a soft bushing. The caster shell seat is locked at the side plane of the bottom end of the traveling suitcase. The roller is pivotally joined with the roller pivotal seat, which is again pivotally joined with the caster shell seat. The soft component and the soft bushing are installed between the caster shell seat and the roller pivotal seat so as to absorb the vibration energy generated when the roller rolls on an uneven ground; the shock absorbing effect of the whole structure can thereby be enhanced. Moreover, the valuable articles in the traveling suitcase can thus be protected, and the lifespan of the roller can also be increased.

### FIELD OF THE INVENTION

The present invention relates to a shock absorbing caster and, more particularly, to an improved shock absorbing caster of a traveling suitcase which can be locked at the bottom edge of a hand-pushed traveling suitcase, and has a shock absorbing capability using the soft plastic installed therein.

### BACKGROUND OF THE INVENTION

As shown in FIG. 1, several casters can be attached at the bottom edge of a general chest or a traveling suitcase to facilitate its mobility. The caster comprises a connecting seat 1a, a rotation seat 2a, a wheel seat 3a, and a plastic wheel 4a. A stop bearing seat 10a is pivotally installed between the connecting seat 1a and the rotation seat 2a so that they can rotate with respect to each other. A pivotal bar 11a is protrusively provided installed at the center of the bottom surface of the connecting seat 1a. An outer thread 12a is formed at the tail end of the pivotal bar 11a. A pivotal hole 20a is formed at the center of the rotation seat 2a. A friction ball bearing 21a is pivotally installed at the periphery of the pivotal hole 20a. The friction ball bearing 21a matches the pivotal bar 11a of the connecting seat 1a. Through the pivotal bar 11a passing the pivotal hole 20a of the rotation seat 2a, the connecting seat 1a can fix the wheel seat 3a using the outer thread 12a thereof. The two ends of the wheel seat 3a are pivotally joined with the plastic wheel 4a.

However, the above caster has the following disadvantages when it is in use.

1. Only the plastic wheel 4a of the above caster has a slight shock absorbing effect. When the caster rolls on an uneven ground, large vibration will be generated so that the valuable articles in the traveling suitcase may be damaged.

2. While heavier articles are loaded in the traveling suitcase, the plastic wheel 4a may in turn be damaged due to larger pressure or impact so that the lifespan of the plastic wheel 4a is reduced.

3. Because the pivotal joining part of almost every component of the caster is made of rigid material, the pivotal joining components may very easily be deformed or damaged due to the longtime action of the vibration forces; therefore, noises may just as easily be generated when the caster is rolling due to imbalance.

The present invention aims at resolving the above mentioned problems of the prior art.

### SUMMARY OF THE INVENTION

The primary object of the present invention is to provide a shock absorbing caster of a traveling suitcase, wherein a soft component is installed between the caster shell seat and the roller pivotal seat to absorb the vibration energy generated when the roller thereof rolls on an uneven ground; the shock absorbing effect is thereby provisioned. By using this design, the valuable articles placed in the traveling suitcase can be protected, and the lifespan of the roller can also be increased.

Another object of the present invention is to provide a shock absorbing caster of a traveling suitcase, wherein a soft bushing having a stud therein is pivotally installed at the caster shell seat so that the roller pivotal seat can form a pivotal shaft having ductility for absorbing vibration forces; the deformation of the pivotal shaft can therefore be prevented.

To achieve the above mentioned objects, the present invention provides a shock absorbing caster of a traveling suitcase. The present invention comprises a caster shell seat, a roller pivotal seat, a roller, and a soft component. The caster shell seat comprises a wheel cover and a connecting plate extended from the periphery of the wheel cover. A wheel-receiving space is formed in the wheel cover. The caster shell seat is locked at the side plane of the bottom end of the traveling suitcase using the connecting plate. The roller pivotal seat comprises a top plate and two pivotal joining plates bent downwards from the two sides of the top plate. The pivotal joining holes are formed at the front and rear ends of the two pivotal joining plates. The pivotal joining holes at the front end are used for pivotally joining the roller. A soft bushing is joined between the pivotal joining holes at the rear end. A pivotal joining element is pivotally joined at the caster shell seat. The soft component sticks and matches between the edge surface of the wheel cover at the top end of the wheel-receiving space and the top plate of the roller pivotal seat. Through the help of the soft component, vibration energy generated when the roller rolls on an uneven ground can be absorbed so as to enhance the shock absorbing capability of the traveling suitcase.

The various objects and advantages of the present invention will be more readily understood from the following detailed description when it is read in conjunction with the appended drawings.

### BRIEF DESCRIPTION OF THE DRAWINGS

FIG. 1 is a cross-sectional view of a prior art caster;

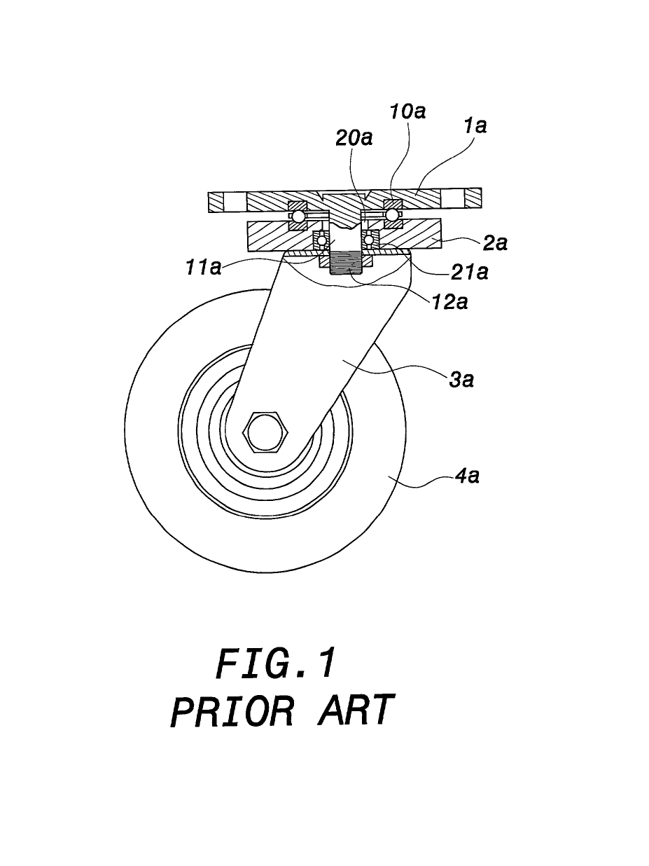

FIG. 2 is an exploded perspective view of the shock absorbing caster of a traveling suitcase of the present invention;

FIG. 3 is a partial perspective view of the shock absorbing caster of a traveling suitcase of the present invention;

FIG. 4 is a perspective view of the shock absorbing caster of a traveling suitcase of the present invention;

FIG. 5 is a side cross-sectional view of the shock absorbing caster of a traveling suitcase of the present invention; and

FIG. 6 is a diagram showing a use state of the shock absorbing caster of a traveling suitcase of the present invention.

### DETAILED DESCRIPTION OF THE PREFERRED EMBODIMENTS

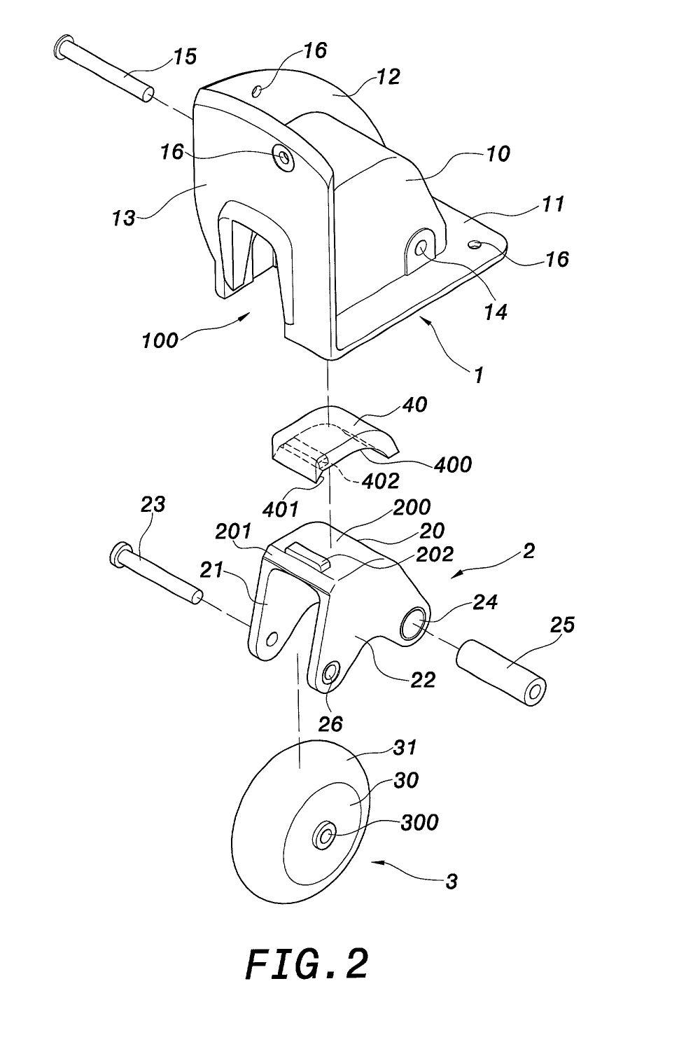

As shown in FIGS. 2 to 5, the shock absorbing caster of the present invention comprises a caster shell seat 1, a roller pivotal seat 2, a roller 3, and a soft component 40.

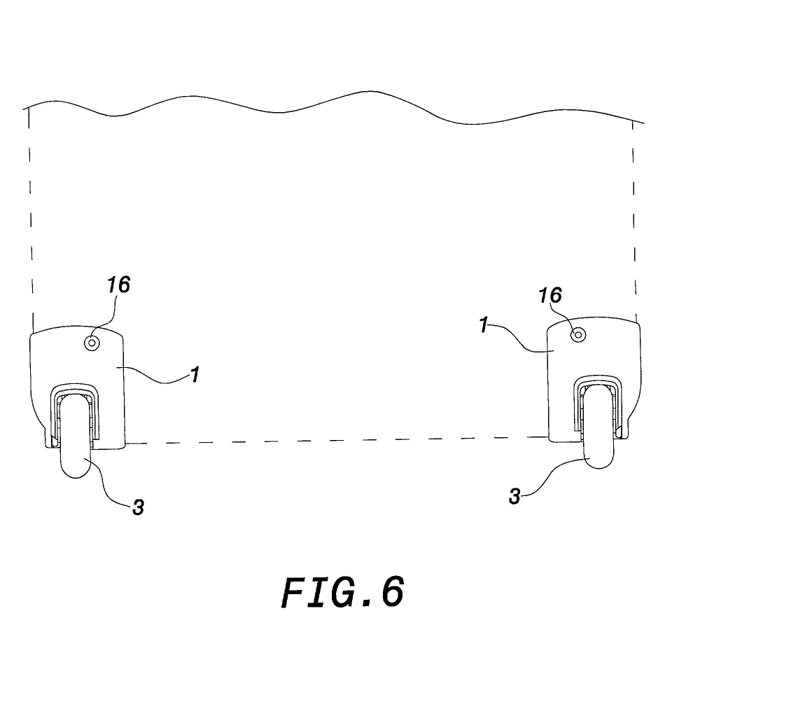

As shown in FIG. 2, the caster shell seat 1 comprises a wheel cover having a wheel-receiving space 100 therein, a bottom plate 11, a side plate 12, and a front plate 13. The bottom plate 11 extends levelly from the bottom edge of the wheel cover 10. The side plate 12 extends vertically from the side of the wheel cover 10. The front plate 13 extends vertically from the front edge of the wheel cover 10. The bottom plate 11, the side plate 12, and the front plate 13 together form the connecting plate of the caster shell seat 1. A plurality of locking holes 16 are formed on the connecting plate. These locking holes 16 are provided for the locking elements (not shown) to fixedly lock the caster shell seat 1 on the side plane of the bottom end of a traveling suitcase, as shown in FIG. 6. A pivotal joining hole 14 is formed near the bottom edge at each side of the wheel cover 10. An opening is formed at the joining position of the wheel cover 10 and the front plate 13 so that the roller 3 can be positioned therein.

The roller pivotal seat 2 comprises a top plate 20 and two pivotal joining plates 21 and 22 bent downwards from the two sides of the top plate 20. The upper edge of the top plate 20 has an arc plane 200 and an inclined plane 201. A rectangular shaped raised bump 202 is transversely formed on the arc plane 200 and is adjacent to the inclined plane 201. Two pivotal joining holes 24 penetrate the rear ends of the lower sections of the two pivotal joining plates 21 and 22, respectively. A soft bushing is joined between the two pivotal joining holes 24. Another two pivotal joining holes 26 penetrate the front ends of the lower sections of the two pivotal joining plates 21 and 22, respectively.

The roller 3 comprises a wheel axle part 30 and a wheel rim part 31 installed at the periphery of the wheel axle part 30. The wheel axle part 30 has a central hole 300, and the wheel rim part is made of rubber material.

The soft component 40 can be a soft material having an arc plane 400 and an inclined plane 401 at the lower edge thereof. A rectangular groove 402 is transversely formed on the arc plane 400 and is also adjacent to the inclined plane 401.

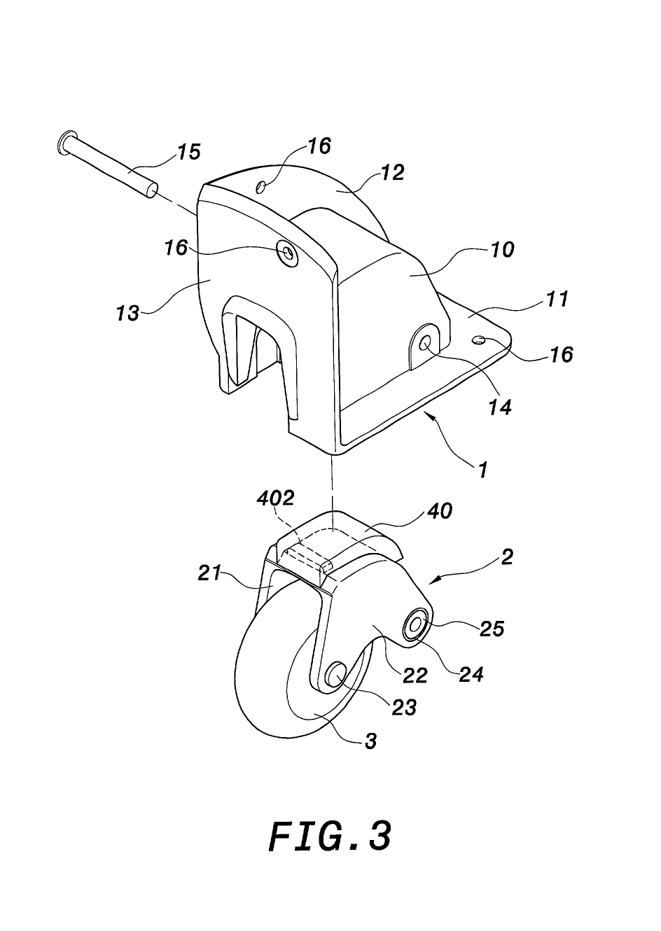

Please refer to FIG. 3. A joining element such as a pin 23 first penetrates the pivotal-joining holes 26 at the front ends of the lower sections of the two pivotal joining plates 21 and 22 of the roller pivotal seat 2. Next, the groove 402 of the soft component 40 is mounted on and attached to the raised bump 202 of the top plate 20 of the roller pivotal seat 2, and the arc plane 400 and the inclined plane 401 respectively match and stick to the arc plane 200 and the inclined plane 201 of the top plate 20 of the roller pivotal seat 2.

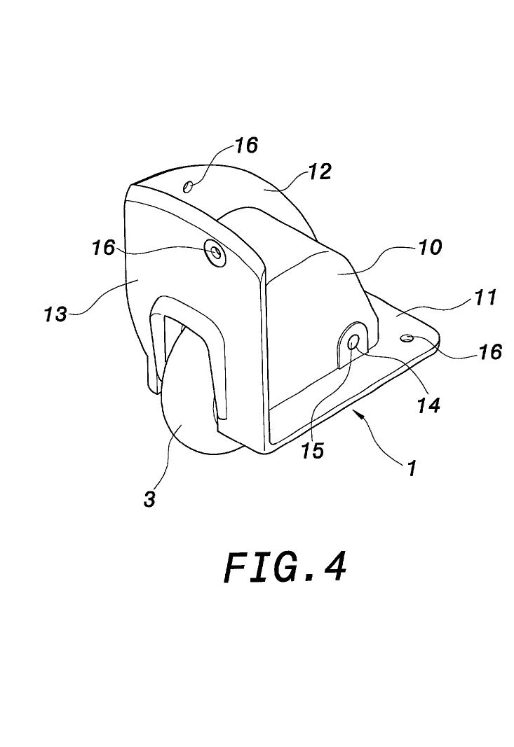

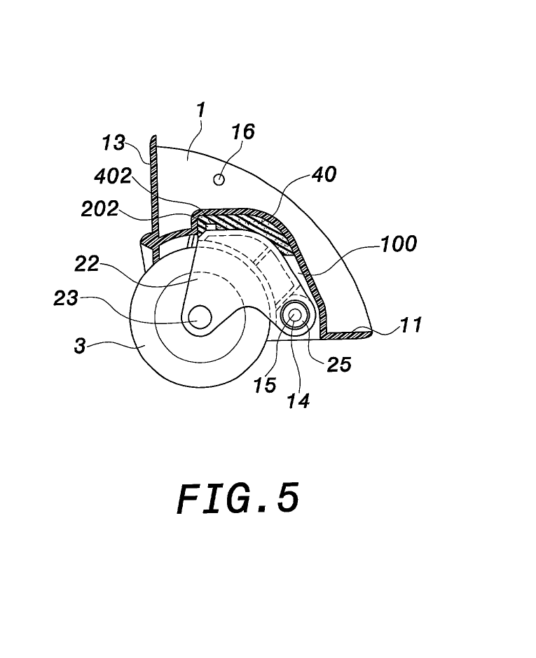

Please further refer to FIGS. 4 and 5. The above assembled roller pivotal seat 2 is placed into the wheel-receiving space 100 of the caster shell seat 1. The upper edge plane of the soft component 40 matches and sticks to the peripheral edge plane of the wheel cover 10 at the top end of the wheel-receiving space 100. A pivotal joining element such as a stud 15 is used to penetrate the soft bushing 25 between the pivotal joining holes 24 at the rear end of the roller pivotal seat 2 to form a pivotal shaft. The caster shell seat 1 and the roller pivotal seat 2 are thus pivotally joined together.

When the traveling suitcase is glided on an uneven ground, the generated vibration energy will be transferred to the inside of the traveling suitcase via roller 3. During the transferring process, most of the vibration energy will be absorbed by the soft component 40 and the soft bushing 25 of the shock absorbing caster of the present invention. Therefore, the generated vibration energy will be effectively muffled to accommodate the caster's shock absorbing capability. Valuable articles in the traveling suitcase can thereby be protected, and the lifespan of the roller can also be increased.

Although the present invention has been described with reference to the preferred embodiments herewith disclosed, it will be understood that the invention is not limited to the details herein discussed. Various substitutions and modifications have been suggested in the foregoing description, and others will occur to those of ordinary skill in the art; therefore, all such substitutions and modifications are intended to be embraced within the scope of the invention as defined in the appended claims.

I claim:

1. A shock absorbing caster of a traveling suitcase, comprising:
a caster shell seat comprising a wheel cover and a connecting plate extending from the periphery of said wheel cover, a wheel-receiving space being formed in said wheel cover, said connecting plate being locked at the bottom end of the traveling suitcase;
a roller pivotal seat comprising a top plate and two pivotal joining plates bent downwards from the two sides of said top plate, pivotal joining holes being formed at the front and rear ends of said two pivotal joining plates, said pivotal joining holes at the front end of said two pivotal joining plates being used for pivotal joining a roller, said pivotal joining holes at the rear end of said two pivotal joining plates being used for joining a soft bushing, said soft bushing being pivotally joined with said caster shell seat using a pivotal joining element; and
a soft component sticking and matching between the edge plane of said wheel cover at the upper end of said wheel-receiving space and said top plate of said roller pivotal seat;
whereby vibration energy generated when said roller rolls on uneven ground can be absorbed by said soft component and said soft bushing so as to enhance the shock absorbing effect of the traveling suitcase.

2. The shock absorbing caster of a traveling suitcase as claimed in claim 1, wherein said connecting plate comprises a bottom plate extending levelly from the bottom edge of said wheel cover, a side plate extending vertically from the side of said wheel cover, and a front plate extending vertically from the front edge of said wheel cover.

3. The shock absorbing caster of a traveling suitcase as claimed in claim 1, wherein the upper edge of said top plate of said roller pivotal seat has an arc plane and an inclined plane, a rectangular raised bump being formed on said arc plane and adjacent to said inclined plane, the lower edge of said soft component having an arc plane and an inclined plane, a rectangular groove being formed on said arc plane and adjacent to said inclined plane, the upper edge of said top plate of said roller pivotal seat corresponding to and being mounted with the lower edge of said soft component.
